(19) United States
(12) Patent Application Publication
(10) Pub. No.: US 2015/0145979 A1
(43) Pub. Date: May 28, 2015

(54) RADIO COMMUNICATION SYSTEM AND COMMUNICATION METHOD

(71) Applicant: OLYMPUS MEDICAL SYSTEMS CORP., Tokyo (JP)

(72) Inventors: Junichi TASHIRO, Higashimurayama-shi (JP); Hideki TASHIRO, Hino-shi (JP); Makoto KASUMI, Hachioji-shi (JP)

(21) Appl. No.: 14/558,180

(22) Filed: Dec. 2, 2014

Related U.S. Application Data
(63) Continuation of application No. PCT/JP2014/063827, filed on May 26, 2014.

(30) Foreign Application Priority Data
May 27, 2013 (JP) 2013-110927

(51) Int. Cl. H04L 1/18; H04N 7/12; H04L 29/06; H04N 7/18

(52) U.S. Cl. CPC H04L 1/1854; H04N 7/185; H04N 7/12; H04L 65/604; H04L 65/4076
USPC 348/65; 370/216

(57) ABSTRACT

A radio communication system, which includes a transmission apparatus that transmits a video signal and a plurality of reception apparatuses that receive the video signal, includes: a storage section that stores information for identifying that a priority related to transmission of the video signal to each of the plurality of reception apparatuses is either a first priority or a second priority lower than the first priority; an error detection section that detects a presence or absence of occurrence of a communication error related to transmission/reception of the video signal; a determination section that determines whether there is a reception apparatus of the first priority among the reception apparatuses in which the communication error is occurring; and a control section that retransmits the video signal only when there is a reception apparatus of the first priority among the reception apparatuses in which the communication error is occurring.

### CROSS REFERENCE TO RELATED APPLICATION

This application is a continuation application of PCT/JP2014/063827 filed on May 26, 2014 and claims benefit of Japanese Application No. 2013-110927 filed in Japan on May 27, 2013, the entire contents of which are incorporated herein by this reference.

### BACKGROUND OF THE INVENTION

1. Field of the Invention

The present invention relates to a radio communication system and more particularly to a radio communication system that transmits and receives a video signal by radio and a communication method.

2. Description of the Related Art

In medical fields, there have been conventionally used systems configured by including an endoscope that picks up an image of an object, a processor that generates a video signal corresponding to an image of an object picked up with the endoscope, and a plurality of reception apparatuses that display and/or store the video signal generated by the processor, for example. In addition, some of the above-described systems have been conventionally configured to transmit and receive a video signal by radio by using a technique related to the radio communication disclosed in Japanese Patent Application Laid-Open Publication No. 2003-273879, for example.

### SUMMARY OF THE INVENTION

A radio communication system according to one aspect of the present invention is a radio communication system including a transmission apparatus configured to transmit a video signal by radio and a plurality of reception apparatuses configured to receive the video signal transmitted from the transmission apparatus by radio, and the radio communication system includes: a storage section that stores information for identifying that a priority related to transmission of the video signal, which is set in each of the plurality of reception apparatuses, is either a first priority or a second priority lower than the first priority; an error detection section that detects a presence or absence of occurrence of a communication error related to transmission and reception of the video signal; a determination section that determines, when the occurrence of the communication error related to the transmission and reception of the video signal is detected by the error detection section, whether or not there is a reception apparatus in which the priority is set to the first priority among the reception apparatuses in which the communication error related to the transmission and reception of the video signal is occurring, with reference to the information stored in the storage section; and a control section that performs control for retransmitting the video signal to the plurality of reception apparatuses only in a case where there is a reception apparatus in which the priority is set to the first priority among the reception apparatuses in which the communication error related to the transmission and reception of the video signal is occurring, based on a determination result of the determination section.

A communication method according to one aspect of the present invention is a communication method in a radio communication system including a transmission apparatus configured to transmit a video signal by radio and a plurality of reception apparatuses configured to receive the video signal transmitted from the transmission apparatus by radio, and the communication method includes: a step of storing, in a storage section, information for identifying that a priority related to transmission of the video signal, which is set in each of the plurality of reception apparatuses, is either a first priority or a second priority lower than the first priority; a step of detecting by an error detection section a presence or absence of occurrence of a communication error related to transmission and reception of the video signal; a step of determining, by a determination section, when the occurrence of the communication error related to the transmission and reception of the video signal is detected by the error detection section, whether or not there is a reception apparatus in which the priority is set to the first priority among the reception apparatuses in which the communication error related to the transmission and reception of the video signal is occurring, with reference to the information stored in the storage section; and a step of performing, by a control section, control for retransmitting the video signal to the plurality of reception apparatuses only in a case where there is a reception apparatus in which the priority is set to the first priority among the reception apparatuses in which the communication error related to the transmission and reception of the video signal is occurring, based on a determination result of the determination section.

### BRIEF DESCRIPTION OF THE DRAWINGS

FIG. 1 is a block diagram showing a configuration of a main part of an endoscope system according to an embodiment of the present invention.

FIG. 2 is a view showing an example of a specific configuration of a video communication section provided in a processor.

FIG. 3 is a view showing an example of a specific configuration of a control communication section provided in the processor.

FIG. 4 is a view showing an example of data used for judging necessity of control related to retransmission of a video signal.

FIG. 5 shows an example of a specific configuration of a video communication section provided to a monitor.

FIG. 6 shows an example of a specific configuration of a control communication section provided to the monitor.

FIG. 7 is a flowchart showing a brief overview of an operation of the endoscope system according to the embodiment.

FIG. 8 is a flowchart showing an example of specific processing and the like performed when a video signal is transmitted in the endoscope system according to the embodiment.

### DETAILED DESCRIPTION OF THE PREFERRED EMBODIMENT(S)

Hereinafter, an embodiment of the present invention will be described with reference to drawings.

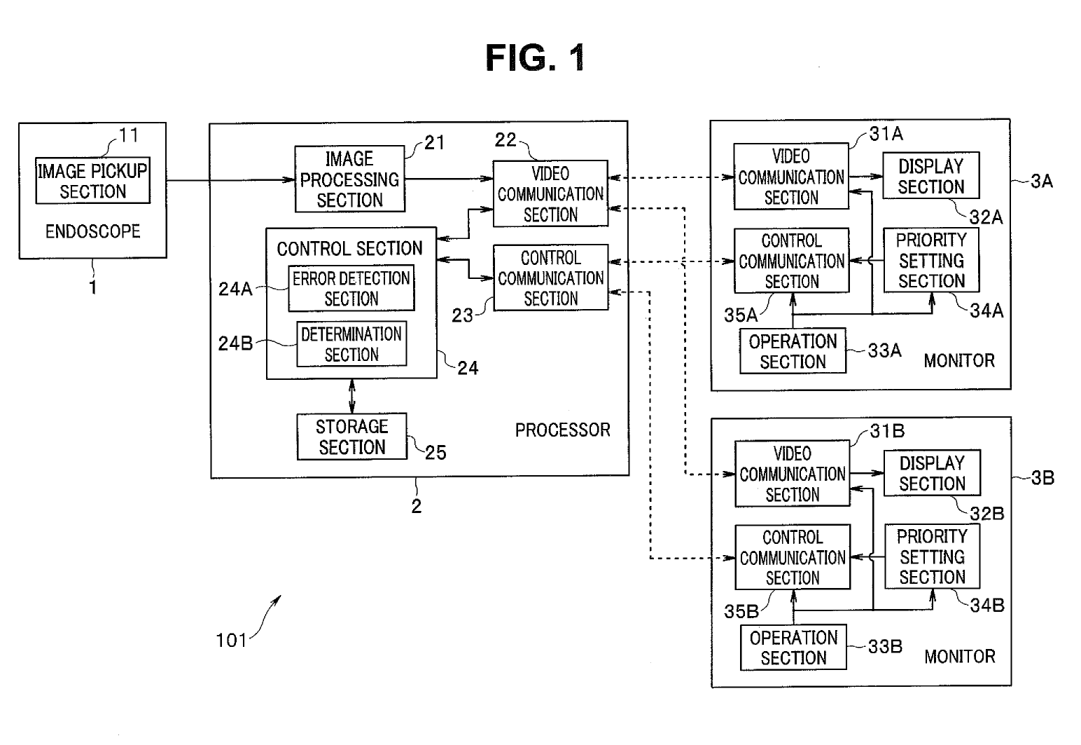

FIGS. 1 to 8 relate to the embodiment of the present invention. FIG. 1 is a block diagram showing a configuration of a main part of an endoscope system according to an embodiment of the present invention.

As shown in FIG. 1, an endoscope system 101 includes an endoscope 1, a processor 2 to which the endoscope 1 is connected, and monitors 3A, 3B, for example.

The endoscope 1 includes an image pickup section 11 configured to pick up an optical image of an object in a body cavity, generate an image pickup signal corresponding to the picked-up optical image of the object, and output the generated image pickup signal to the processor 2. Note that the endoscope system 101 according to the present embodiment is not limited to the one configured by including, in the endoscope 1, the image pickup section 11 for picking up an optical image of an object, but may be the one configured by including, in the processor 2, an image pickup section 11 for picking up an optical image of an object obtained with a rigid endoscope, a fiber scope, or the like, for example.

The processor 2 is configured to generate a video signal corresponding to the image pickup signal outputted from the endoscope 1 and transmit the generated video signal by radio. In addition, as shown in FIG. 1, for example, the processor 2 includes an image processing section 21, a video communication section 22, a control communication section 23, a control section 24, and a storage section 25.

The image processing section 21 is configured to perform various kinds of image processing on the video signal outputted from the endoscope 1 to generate a video signal, and output the generated video signal to the video communication section 22.

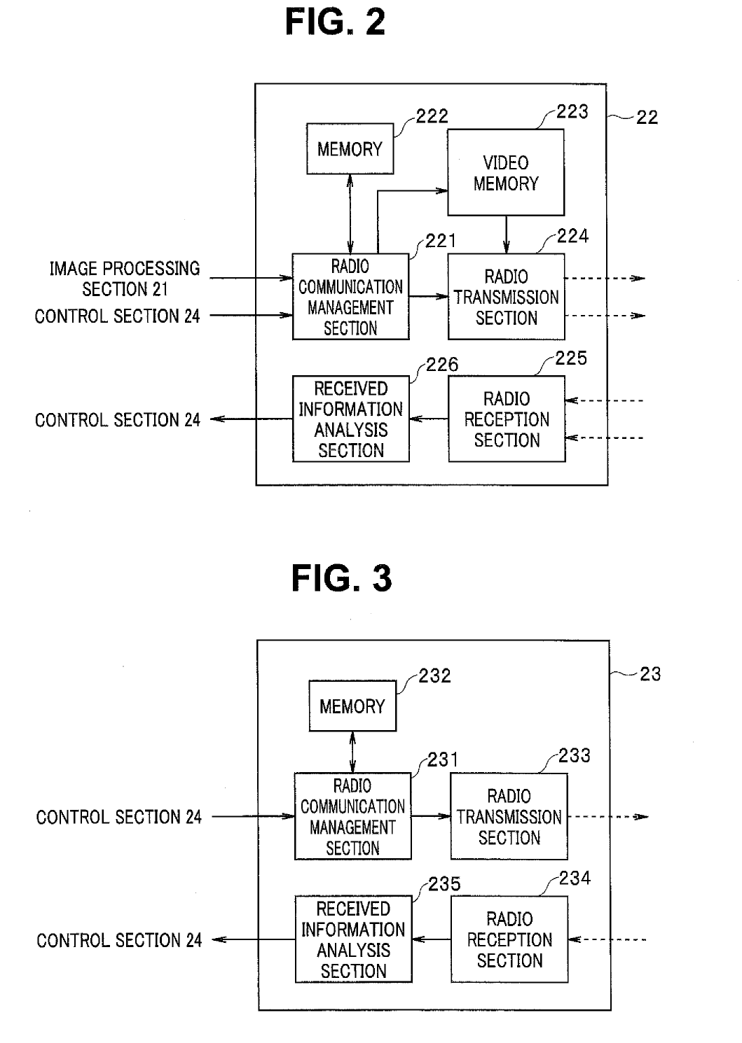

As shown in FIG. 2, for example, the video communication section 22 includes a radio communication management section 221, a memory 222 in which information (ID value or MAC address, etc.) related to transmission destinations of the video signal is stored, a video memory 223 having a capacity capable of accumulating the video signal for predetermined number of frames, a radio transmission section 224, a radio reception section 225, and a received information analysis section 226. FIG. 2 is a view showing an example of a specific configuration of a video communication section provided in the processor.

The radio communication management section 221 is configured to output the video signal outputted from the image processing section 21 to the video memory 223 and the radio transmission section 224. In addition, the radio communication management section 221 is configured to control the radio transmission section 224 to cause the radio transmission section to transmit the video signal to the respective transmission destinations included in the information stored in the memory 222, based on the control by the control section 24. Further, the radio communication management section 221 is configured to update the information related to the transmission destinations of the video signal, which is stored in the memory 222, in response to the control by the control section 24. Furthermore, the radio communication management section 221 is configured to, when control related to retransmission of the video signal is performed by the control section 24, specify a frame to be retransmitted from the video signal accumulated in the video memory 223, and transmit the video signal for the specified frame to the respective transmission destinations included in the information stored in the memory 222.

The radio transmission section 224 is configured to generate a radio signal by modulating the video signal outputted from the radio communication management section 221 or the video memory 223, to transmit the generated radio signal to the respective transmission destinations (monitor 3A and monitor 3B).

A radio reception section 225 is configured to receive radio signals outputted from a video communication section 31A (to be described later) of the monitor 3A and a video communication section 3113 (to be described later) of the monitor 3B, demodulate the received radio signals to thereby restore information related to an error rate included in the radio signals, and output the restored information related to the error rate to the received information analysis section 226.

The received information analysis section 226 is configured to detect, based on the information related to the error rate outputted from the radio reception section 225, the presence or absence of error occurrence at the time when a video signal for one frame is received by the monitor 3A and the presence or absence of error occurrence at the time when the video signal for the one frame is received by the monitor 3B, and output information related to the detected presence or absence of the error occurrence to the control section 24.

The control communication section 23 includes, as shown in FIG. 3, for example, a radio communication management section 231, a memory 232 in which information (ID value or MAC address, etc.) related to transmission destinations of the communication control information outputted from the control section 24 is stored, a radio transmission section 233, a radio reception section 234, and a received information analysis section 235. FIG. 3 is a view showing an example of a specific configuration of control communication section provided in the processor.

The radio communication management section 231 is configured to output communication control information outputted from the control section 24 to the radio transmission section 233. In addition, the radio communication management section 231 is configured to control the radio transmission section 233 to cause the radio transmission section to transmit the communication control information to the respective transmission destinations included in the information stored in the memory 232. Furthermore, the radio communication management section 231 is configured to update the information related to the transmission destinations of the communication control information, which is stored in the memory 232, in response to the control by the control section 24.

The radio transmission section 233 is configured to generate a radio signal by modulating the communication control information outputted from the radio communication management section 231, and transmit the generated radio signal to the respective transmission destinations (monitor 3A and monitor 3B).

The radio reception section 234 is configured to receive the radio signals outputted from a control communication section 35A (to be described later) of the monitor 3A and a control communication section 35B (to be described later) of the monitor 3B, demodulate the received radio signals to thereby restore the information related to the error rate included in the radio signals, and output the restored information related to the error rate to the received information analysis section 235. In addition, the radio reception section 234 is configured to receive the radio signals outputted from the control communication section 35A (to be described later) of the monitor 3A and the control communication section 35B (to be described later) of the monitor 3B, and is configured, when acquiring information related to priority by demodulating the received radio signals, to output the acquired information related to the priority to the received information analysis section 235.

The received information analysis section 235 is configured to detect, based on the information related to the error rate outputted from the radio reception section 234, the presence or absence of error occurrence at the time when the communication control information transmitted at one timing is received by the monitor 3A and the presence or absence of error occurrence at the time when the communication control information transmitted at the one timing is received by the monitor 3B, respectively, and output information related to the detected presence or absence of the error occurrence to the control section 24. In addition, the received information analysis section 235 is configured to output the information related to the priority acquired by the radio reception section 234 to the control section 24.

The control section 24 is configured to perform various settings related to the operation of the processor 2 such as setting of a radio channel used for transmission and reception of the respective radio signals in the video communication section 22 and the control communication section 23, based on the signal outputted through an input interface (not shown) provided to the processor 2. In addition, the control section 24 is configured to store the various settings related to the respective sections of the processor 2 in the storage section 25. Furthermore, the control section 24 is configured to perform control for causing the respective sections in the processor 2 to be operated, based on the settings stored in the storage section 25. The control section 24 is configured by including an error detection section 24A and a determination section 24B.

Note that an input interface provided to the processor 2 receives signals outputted from a scope switch (not shown) of the endoscope 1, a touch panel (not shown), a panel switch (not shown) on which radio link buttons (not shown) are provided and a serial communication line (not shown) for remotely performing the settings, etc., of the processor 2, for example.

The control section 24 is configured to generate communication control information including a predetermined data string available for detecting the communication state of radio communication, for example, and output the generated communication control information to the radio communication management section 231.

The error detection section 24A of the control section 24 is configured to detect the presence or absence of error occurrence in each of the monitors 3A and 3B, based on the information related to the presence or absence of the error occurrence outputted from at least one of the received information analysis section 226 and the received information analysis section 235, and update a table data TD (to be described later) stored in the storage section 25 according to the detection result.

The control section 24 is configured to update the table data TD stored in the storage section 25, based on the information related to the priority outputted from the received information analysis section 235.

The determination section 24B of the control section 24 is configured to perform, when the error detection section 24A detects that a communication error has occurred in at least one of the monitors 3A and 3B, predetermined determination processing (to be described later) with reference to the latest information written in the table data TD stored in the storage section 25. In addition, the control section 24 is configured to judge, based on the determination result acquired by the determination processing performed by the determination section 24B, the necessity of retransmission of the video signal at the time when the communication error occurs in the monitor 3A and/or the monitor 3B, and perform control related to retransmission of the video signal on the radio communication management section 221 according to the judgment result.

In the case where the priority for the monitor 3A is “high” and the priority for the monitor 3B is “high”, for example, the control section 24 performs control related to retransmission of the video signal on the radio communication management section 221 when the communication error has occurred either in the monitor 3A or the monitor 3B.

In addition, in the case where the priority for the monitor 3A is “high” and the priority for the monitor 3B is “low”, for example, the control section 24 performs control related to retransmission of the video signal on the radio communication management section 221 only when the communication error has occurred in the monitor 3A.

Furthermore, in the case where the priority for the monitor 3A is “low” and the priority for the monitor 3B is “high”, for example, the control section 24 performs control related to retransmission of the video signal on the radio communication management section 221 only when the communication error has occurred in the monitor 3B.

On the other hand, in the case where the priority for the monitor 3A is “low” and the priority for the monitor 3B is “low”, for example, the control section 24 does not perform control related to retransmission of the video signal on the radio communication management section 221 even if the communication error has occurred in one of or both of the monitor 3A and monitor 3B.

The storage section 25 stores various settings related to the operation of the processor 2. In addition, the storage section 25 stores the table data TD used for judging the necessity of the control related to retransmission of the video signal by the control section 24.

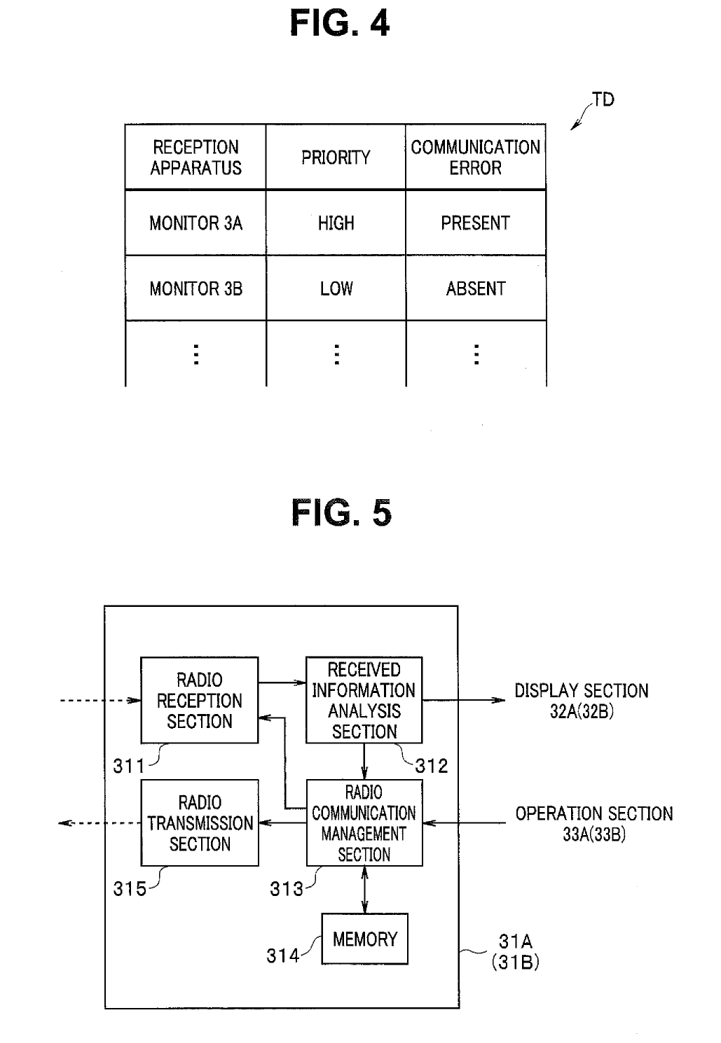

Specifically, the table data TD is configured as data in which the presence or absence of occurrence of the communication error and the priority related to the transmission of the video signal are associated with each other for each of the reception apparatuses which are transmission destinations of the video signal, for example, as shown in FIG. 4. That is, the table data TD having such a configuration enables the priority related to transmission of the video signal set in each of the plurality of reception apparatuses to be identified as either “high” or “low”. FIG. 4 is a view showing an example of data used for judging the necessity of control related to retransmission of the video signal.

The monitor 3A is configured to receive the video signal transmitted from the processor 2 by radio. In addition, as shown in FIG. 1, for example, the monitor 3A includes the video communication section 31A, a display section 32A, an operation section 33A, a priority setting section 34A, and the control communication section 35A.

The video communication section 31A includes, as shown in FIG. 5, for example, a radio reception section 311, a received information analysis section 312, a radio communication management section 313, a memory 314 in which information (ID value or MAC address, etc.) related to the transmission source of the video signal is stored, and a radio transmission section 315. FIG. 5 shows an example of a specific configuration of a video communication section provided to each of the monitors.

The radio reception section 311 is configured to receive a radio signal outputted from the video communication section 22 of the processor 2, restore the video signal by demodulating the received radio signal, and output the restored video signal to the received information analysis section 312.

The received information analysis section 312 is configured to convert the format of the video signal outputted from the radio reception section 311 to a format compatible with the display section 32k and output the video signal subjected to the format conversion. In addition, the received information analysis section 312 is configured to calculate the error rate of the video signal outputted from the radio reception section 311, and output information related to the calculated error rate to the radio communication management section 313.

The radio communication management section 313 is configured to set, when the radio link button (not shown) of the operation section 33A is operated, the radio channel used for transmission and reception of radio signals in the radio reception section 311 and the radio transmission section 315, and update information related to the transmission source of the video signal stored in the memory 314. In addition, the radio communication management section 313 is configured to control the radio transmission section 315 to cause the radio transmission section to transmit the information related to the error rate outputted from the received information analysis section 312 to the transmission source of the video signal included in the information stored in the memory 314.

The radio transmission section 315 is configured to generate a radio signal by modulating the information related to the error rate outputted from the radio communication management section 313, and transmit the generated radio signal to the transmission source (processor 2) of the video signal.

The display section 32A is configured to display an image corresponding to the video signal outputted from the received information analysis section 312 of the video communication section 31A, for example.

The operation section 33A is configured by including, for example, user interfaces such as the radio link button to be operated when establishing radio connection between the monitor and the processor 2, a priority switching switch (not shown) with which the priority related to transmission of the video signal can be manually switched, and the like.

The priority setting section 34A is configured to set the priority related to transmission of the video signal to either “high” or “low”, on the basis of the operation performed with the priority switching switch of the operation portion 33A, store the information related to the set priority, and output the information to the control communication section 35A. Note that, in the present embodiment, only when the switching of the priority (from “high” to “low”, or “low” to “high”) occurs, the information related to the priority is outputted from the priority setting section 34A to the control communication section 35A.

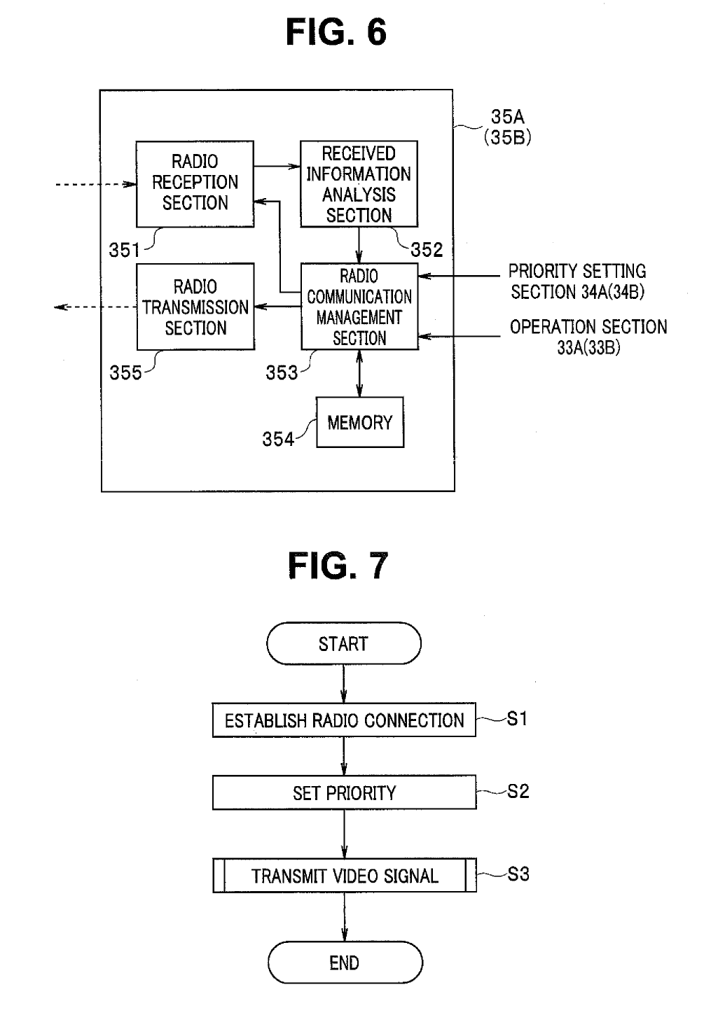

The control communication section 35A includes, as shown in FIG. 6, for example, a radio reception section 351, a received information analysis section 352, a radio communication management section 353, a memory 354 in which information (ID value or MAC address, etc.) related to the transmission source of the communication control information is stored, and a radio transmission section 355. FIG. 6 shows an example of a specific configuration of a control communication section provided in each of the monitors.

The radio reception section 351 is configured to receive the radio signal outputted from the control communication section 23 of the processor 2, restore the communication control information by demodulating the received radio signal, and output the restored communication control information to the received information analysis section 352.

The received information analysis section 352 is configured to calculate the error rate of a predetermined data string included in the communication control information outputted from the radio reception section 351 and output information related to the calculated error rate to the radio communication management section 353.

The radio communication management section 353 is configured to, when the radio link button (not shown) of the operation section 33A is operated, set the radio channel used for transmission and reception of radio signals in the radio reception section 351 and the radio transmission section 355 and update information related to the transmission source of the video signal stored in the memory 354. In addition, the radio communication management section 353 is configured to control the radio transmission section 355 to cause the radio transmission section to transmit the information related to the error rate outputted from the received information analysis section 352 to the transmission source of the communication control information included in the information stored in the memory 354. In addition, the radio communication management section 353 is configured to control the radio transmission section 355 to cause the radio transmission section to transmit the information related to priority outputted from the priority setting section 34A to the transmission source of the communication control information included in the information stored in the memory 354.

The radio transmission section 355 is configured to generate a radio signal by modulating the information related to the error rate outputted from the radio communication management section 353 and transmit the generated radio signal to the transmission source (processor 2) of the communication control information.

The monitor 3B is configured to receive the video signal transmitted by radio from the processor 2. In addition, as shown in FIGS. 1, 5, and 6, for example, the monitor 3B includes the video communication section 31B having the same configuration as that of the video communication section 31A, a display section 32B having the same configuration as that of the display section 32A, an operation section 33B having the same configuration as that of the operation section 33A, a priority setting section 34B having the same configuration as that of the priority setting section 34A, and the control communication section 35B having the same configuration as that of the control communication section 35A. Therefore, detailed description on the configuration of the monitor 3B will be omitted.

Next, working of the endoscope system 101 of the present embodiment will be described. FIG. 7 is a flowchart showing a brief overview of the operation of the endoscope system according to the embodiment.

First, a user such as a medical doctor connects the endoscope 1 to the processor 2, and turns on the power sources of the respective sections of the endoscope system 101, with the processor 2, the monitor 3A and the monitor 3B being arranged within the communication range available for radio communication.

After that, the user operates the radio link buttons provided respectively on the panel switch of the processor 2, the operation section 33A of the monitor 3A, and the operation section 33B of the monitor 3B. Then, in response to such operation by the user, the radio channel to be used for transmission and reception of a radio signal is set, the information related to the transmission destinations of the video signal and the communication control information is updated, and information related to the transmission sources of the video signal and the communication control information is updated, thereby allowing the radio connection to be established between the processor 2 and the monitor 3A, and also allowing the radio connection to be established between the processor 2 and the monitor 3B (step S1 in FIG. 7).

On the other hand, the control section 24 performs processing for erasing the existing information (at the time of previous use) written in the table data TD of the storage section 25 at any timing after the power sources of the respective sections of the endoscope system 101 are turned on until the processing in the step Si in FIG. 7 is completed.

The user operates the respective priority switching switches of the operation section 33A and the operation section 33B. Then, in response to such operation by the user, the priority related to transmission of the video signal is set in each of the monitor 3A and the monitor 3B, information related to the set priority is transmitted to the processor 2, and the information written in the table data TD of the storage section 25 is updated (step S2 in FIG. 7).

In the state where the radio connection according to the step S1 in FIG. 7 is established, and the setting of the priority according to the step S2 in FIG. 7 is performed, the user operates an examination start switch (not shown) provided on the panel switch of the processor 2. Then, in response to such an operation by the user, a video signal corresponding to the image of a desired object picked up with the endoscope 1 is generated, and the generated video signal is transmitted to the monitors 3A and 3B until an examination completion switch (not shown) provided on the panel switch of the processor 2 is operated (by the user) (step S3 in FIG. 7).

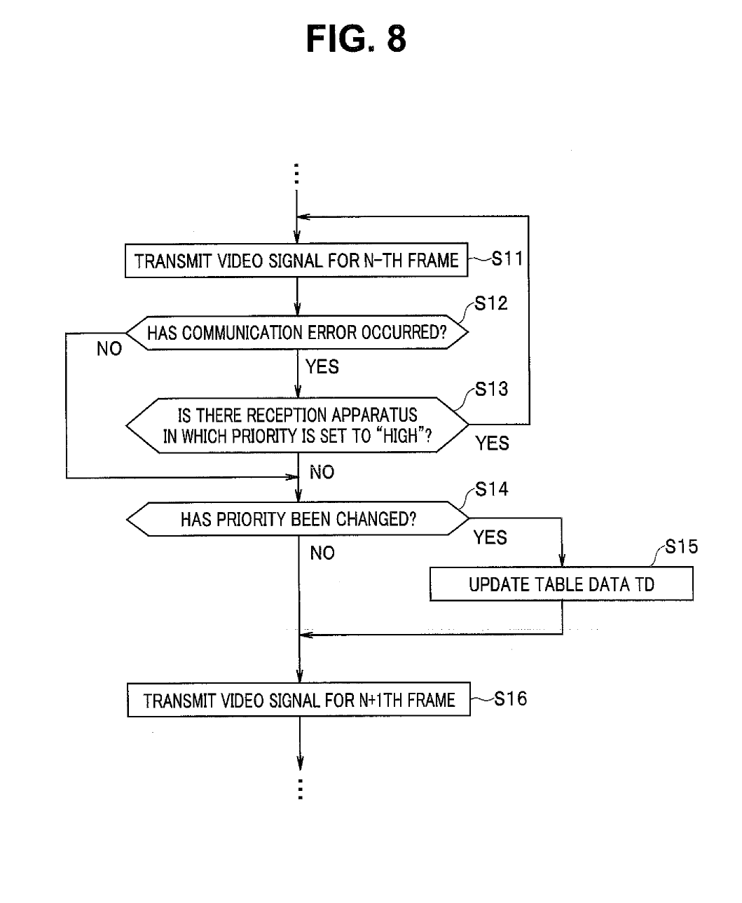

Here, description will be made on specific processing and the like performed when the video signal is transmitted in the step S3 in FIG. 7. Note that, hereinafter description will be made, for simplification, by extracting processing and the like performed in the period from the transmission timing of the video signal for the N-th (N≧1) frame until the transmission timing of the video signal for the N+1th frame. FIG. 8 is a flowchart showing an example of specific processing and the like performed in the endoscope system according to the embodiment when a video signal is transmitted. The control section 24 controls the video communication section 22 to cause the video communication section to transmit the video signal for the N-th frame to the monitor 3A and the monitor 3B, and generates communication control information including a predetermined data string, to output the generated communication control information to the control communication section 23 (step S11 in FIG. 8).

The error detection section 24A of the control section 24 detects the presence or absence of occurrence of a communication error related to the transmission and reception of the video signal for the N-th frame, based on the information related to the presence or absence of error occurrence outputted from at least one of the received information analysis section 226 and the received information analysis section 235 after the processing in the step S11 in FIG. 8 is performed, and updates the table data TD in the storage section 25 based on the result of the detection (step S12 in FIG. 8).

That is, according to the processing in the step S11 and step S12 in FIG. 8, every time the video signal for one frame is transmitted from the processor 2 to the monitor 3A and the monitor 3B, the control section 24 detects the presence or absence of occurrence of the communication error related to the transmission and reception of the video signal.

When the control section 24 detects by the processing in the step S12 in FIG. 8 that no communication error related to the transmission and reception of the video signal for the N-th frame occurs in both of the monitors 3A and 3B, the control section 24 proceeds to the processing in the step S14 in FIG. 8, to be described later.

Furthermore, when the determination section 24B of the control section 24 detects by the processing in the step S12 in FIG. 8 that the communication error related to the transmission and reception of the video signal for the N-th frame is occurring in at least one of the monitor 3A and the monitor 3B, the determination section 24B determines whether or not there is a reception apparatus (monitor) in which the priority is set to “high” among the respective reception apparatuses (monitors) in which the communication error related to the transmission and reception of the video signal for the N-th frame is occurring, with reference to the latest information written in the table data TD (step S13 in FIG. 8).

When the control section 24 acquires, by the processing in the step S13 in FIG. 8, the determination result indicating that there is a reception apparatus (monitor) in which the priority is set to “high” among the respective reception apparatuses (monitors) in which the communication error related to the transmission and reception of the video signal for the N-th frame is occurring, the control section 24 judges that retransmission of the video signal for the N-th frame is necessary and thereafter performs the processing in the step S11 in FIG. 8 again.

In addition, when the control section 24 acquires, by the processing in the step S13 in FIG. 8, the determination result indicating that there is no reception apparatus (monitor) in which the priority is set to “high” among the respective reception apparatuses (monitors) in which the communication error related to the transmission and reception of the video signal for the N-th frame is occurring, the control section 24 judges that retransmission of the video signal for the N-th frame is not necessary, and proceeds to the processing in the step S14 in FIG. 8, to be described later.

That is, according to the processing in the step S12 and the step S13 in FIG. 8, only in the case where there is a reception apparatus (monitor) in which the priority is set to “high” among the respective reception apparatuses (monitors) in which the communication error related to the transmission and reception of the video signal for the N-th frame is occurring, the control section 24 performs control related to the retransmission of the video signal for the N-th frame on the video communication section 22.

On the other hand, the control section 24 judges a presence or absence of a change in the priority for the monitor 3A and/or 3B, based on the detection result regarding whether the information related to the priority has been outputted from the received information analysis section 235 (step S14 in FIG. 8).

When the control section 24 detects that the information related to the priority is not outputted from the received information analysis section 235 in the step S14 in FIG. 8, the control section 24 judges that the priority has not been changed both for the monitor 3A and the monitor 3B, and proceeds to the processing in the step S16 in FIG. 8, to be described later.

Furthermore, the control section 24 having a function as an information updating section judges, when detecting that the information related to the priority has been outputted from the received information analysis section 235, that there is a change in the priority for the monitor 3A and/or the priority for the monitor 3B in the step S14 in FIG. 8, and updates the table data TD according to the changed priority included in the information (step S15 in FIG. 8), thereafter proceeds to the processing in step S16 in FIG. 8, to be described later.

The control section 24 controls the video communication section 22 to cause the video communication section to transmit the video signal for the N+1th frame to the monitor 3A and the monitor 3B, and generates a communication control information including a predetermined data string to output the generated communication control information to the control communication section 23 (step S16 in FIG. 8).

As described above, according to the present embodiment, when the priority for one of the monitors 3A and 3B, which is used by a medical doctor or the like in order to make diagnosis during a surgery, is set to “high” and the priority for the other of the monitors 3A and 3B, which is used by a nurse or the like who is not directly involved in the surgery in order to check the process of the surgery, is set to “low”, for example, it is possible to continue transmission of a video signal to the one monitor irrespective of the presence or absence of the occurrence of the communication error in the other monitor, and also possible to surely retransmit the video signal when the communication error is occurring in the one of the monitors. In addition, according to the present embodiment, the presence or absence of occurrence of the communication error related to the transmission and reception of the video signal is detected at a predetermined frequency (for example, every time a video signal for one frame is transmitted), thereby suppressing a reduction in image quality of the image displayed on the monitor 3A and the monitor 3B in accordance with the retransmission of the video signal. As a result, the present embodiment enables the reliability of the diagnosis during a surgery to be improved.

Note that the present embodiment is not limited to the configuration in which only the display apparatuses such as the monitors 3A and 3B are included as the transmission destinations of the video signal, but may be a configuration in which a video recorder that is capable of storing the video signal transmitted from the processor 2 and/or a printer that is capable of printing an arbitrary still image included in the video signal transmitted from the processor 2 is included as the transmission destination of the video signal, for example.

Alternatively, the configuration of the endoscope system 101 according to the present embodiment may be appropriately modified to configure a radio endoscope system including a radio endoscope having the endoscope 1 and the respective sections (image processing section 21, video communication section 22, control communication section 23, control section 24 and storage section 25) of the processor 2, and the monitors 3A and 3B, for example.

In addition, the present embodiment may be configured such that the priority related to transmission of a video signal is set (switched) to either “high” or “low” in response to the operation of an external apparatus which is remotely connected to the monitor 3A and the monitor 3B, for example.

Furthermore, the present embodiment may be configured so as to cause an external apparatus which is remotely connectable to the processor 2 to store and update the table data TD, and cause the external apparatus to perform a series of processing in FIG. 8, for example.

Furthermore, the present embodiment may be configured such that the video communication section 22 includes a plurality of radio transmission sections that generate radio signals in bands different for each of the types of the reception apparatuses, for example. Specifically, the video communication section 22 may be configured to include a first radio transmission section configured to generate a radio signal in the 60 GHz band and transmit the generated radio signal to the monitor, a second radio transmission section configured to generate a radio signal in the 5 GHz band and transmit the generated radio signal to the video recorder, and a third radio transmission section configured to generate a radio signal in the 2.4 GHz band and transmit the generated radio signal to the printer, for example.

Note that the present invention is not limited to the above-described embodiment, and it is needless to say that various changes and applications are possible without departing from the gist of the invention.

What is claimed is:

1. A radio communication system which comprises a transmission apparatus configured to transmit a video signal by radio and a plurality of reception apparatuses configured to receive the video signal transmitted from the transmission apparatus by radio, the radio communication system comprising:
a storage section that stores information for identifying that a priority related to transmission of the video signal, which is set in each of the plurality of reception apparatuses, is either a first priority or a second priority lower than the first priority;
an error detection section that detects a presence or absence of occurrence of a communication error related to transmission and reception of the video signal;
a determination section that determines, when the occurrence of the communication error related to the transmission and reception of the video signal is detected by the error detection section, whether or not there is a reception apparatus in which the priority is set to the first priority among the reception apparatuses in which the communication error related to the transmission and reception of the video signal is occurring, with reference to the information stored in the storage section; and
a control section that performs control for retransmitting the video signal to the plurality of reception apparatuses only in a case where there is a reception apparatus in which the priority is set to the first priority among the reception apparatuses in which the communication error related to the transmission and reception of the video signal is occurring, based on a determination result of the determination section.

2. The radio communication system according to claim 1, wherein the error detection section detects the presence or absence of the occurrence of the communication error related to the transmission and reception of the video signal every time when the video signal for one frame is transmitted from the transmission apparatus to the plurality of reception apparatuses.

3. The radio communication system according to claim 1, further comprising an information updating section that updates the information stored in the storage section when the priory related to the transmission of the video signal in each of the plurality of reception apparatuses is changed.

4. The radio communication system according to claim 1, further comprising a priority setting section that sets the priority related to the transmission of the video signal to either the first priority or the second priority.

5. The radio communication system according to claim 1, wherein the priority related to the transmission of the video signal is set to either the first priority or the second priority, in response to operation of an external apparatus which is remotely connected to each of the plurality of reception apparatuses.

6. The radio communication system according to claim I, wherein the transmission apparatus includes the storage section, the error detection section, the determination section, and the control section.

7. The radio communication system according to claim 6, wherein the transmission apparatus includes an image pickup section that picks up an image of an object in a body cavity, an image processing section that generates a video signal corresponding to the image of the object picked up with the image pickup section, a radio transmission section that generates a radio signal corresponding to the video signal to transmit the generated radio signal by radio to the plurality of reception apparatuses.

8. The radio communication system according to claim 6, wherein the transmission apparatus further includes an image processing section that generates a video signal corresponding to an image of an object picked up with an image pickup section that picks up the image of the object in a body cavity, and a radio transmission section that generates a radio signal corresponding to the video signal to transmit the generated radio signal by radio to the plurality of reception apparatuses.

9. The radio communication system according to claim 1, wherein the plurality of reception apparatuses are a plurality of monitors.

10. A communication method in a radio communication system including a transmission apparatus configured to transmit a video signal by radio and a plurality of reception apparatuses configured to receive the video signal transmitted from the transmission apparatus by radio, the communication method comprising:
a step of storing, in a storage section, information for identifying that a priority related to transmission of the video signal, which is set in each of the plurality of reception apparatuses, is either a first priority or a second priority lower than the first priority;
a step of detecting by an error detection section a presence or absence of occurrence of a communication error related to transmission and reception of the video signal;
a step of determining, by a determination section, when the occurrence of the communication error related to the transmission and reception of the video signal is detected by the error detection section, whether or not there is a reception apparatus in which the priority is set to the first priority among the reception apparatuses in which the communication error related to the transmission and reception of the video signal is occurring, with reference to the information stored in the storage section; and
a step of performing, by a control section, control for retransmitting the video signal to the plurality of reception apparatuses only in a case where there is a reception apparatus in which the priority is set to the first priority among the reception apparatuses in which the communication error related to the transmission and reception of the video signal is occurring, based on a determination result of the determination section.
